(19) United States
(12) Patent Application Publication
(10) Pub. No.: US 2006/0230141 A1
(43) Pub. Date: Oct. 12, 2006

(54) Method of routing and managing advertising feedback data

(76) Inventor: Daniel Willis, Stittsville (CA)

Correspondence Address: FREEDMAN & ASSOCIATES, 117 CENTREPOINTE DRIVE, SUITE 350, NEPEAN, ONTARIO, K2G 5X3, CA

(21) Appl. No.: 11/397,734

(22) Filed: Apr. 5, 2006

Related U.S. Application Data
(60) Provisional application No. 60/668,085, filed on Apr. 5, 2005.

(51) Int. Cl. G06F 15/173

(52) U.S. Cl. 709/224

(57) ABSTRACT

The action of impressing an advertisement within a virtual environment of a video game is stored in a log file. The log file has a public portion and a private portion. The log file is provided to a server that determines an appropriate destination for the log file based upon data within the public portion of the log file. The private portion of the log file is optionally encrypted using a unique identifier to complicate unauthorized duplication of log files.

### FIELD OF THE INVENTION

The invention relates to reporting data. More specifically, the invention relates to providing and managing data relating to impressions occurring during a video game session.

### BACKGROUND OF THE INVENTION

In order to provide exposure of the products and services of their clients, advertisers are turning from traditional methods of advertising such as television, radio and signage to advertising using computing platforms. One such approach involves displaying advertisements to a person playing a video game, a gamer. In the art, providing an advertisement to a target individual is referred to as an impression and can include audio impressions, video impressions, images, etc. One complication in providing such impressions is that it is often difficult to determine exactly what a person playing a game has seen over the course of an extended period of time. Additionally, as video games increase in popularity and the use of advertising in video games increases, it is apparent that a substantial amount of data is necessary to provide reports associated with impressions provided to a group of users as well as some relative measure of the quality of the impressions.

A further complication is that data associated with advertising impressions is valuable. Specifically, unscrupulous persons might be inclined to provide reports falsely indicating that impressions that have not occurred have occurred. This benefits these persons by supporting a fictitious invoice for advertising impressions that were not. For example, Internet banner advertising was subject to significant problems when software robots were used to revisit a page including the banner repeatedly and automatically in order to artificially inflate impression counts. Advertisers who paid for advertising based on impression counts were thereby overpaying, paying based on less than honest statistical data. Clearly, advertisers do not want to overpay.

It would be beneficial to provide a system for effectively and accurately providing data associated with advertising in video games.

### SUMMARY OF INVENTION

The invention teaches a method of providing feedback data relating to advertising content, comprising: providing an advertisement during the video game session, the video game session occurring on a video game system; providing a log file in dependence upon the advertisement, the log file comprising a public portion and a private portion; providing the log file from the video game system to a first server; and, determining a destination for the log file at the first server, the destination determined in dependence upon data present within the public portion of the log file.

The invention also teaches a method comprising: providing an advertisement during a video game session, the video game session occurring on a video game system and forming part of a massively multiplayer online game; providing a log file on a first server and in dependence upon the advertisement, the log file comprising a public portion and a private portion; providing impression data from the video game system to the first server; and, storing the impression data within the log file associated with the advertisement.

### BRIEF DESCRIPTION OF THE DRAWINGS

The invention is now described with reference to the figures in which:

FIG. 1 is a schematic diagram of video game advertising system;

FIG. 2 is a drawing representative of the contents of a log file; and,

FIG. 3 is a schematic diagram of a video game advertising system having a triage server and log file servers according to a third embodiment of the invention.

### DETAILED DESCRIPTION OF THE INVENTION

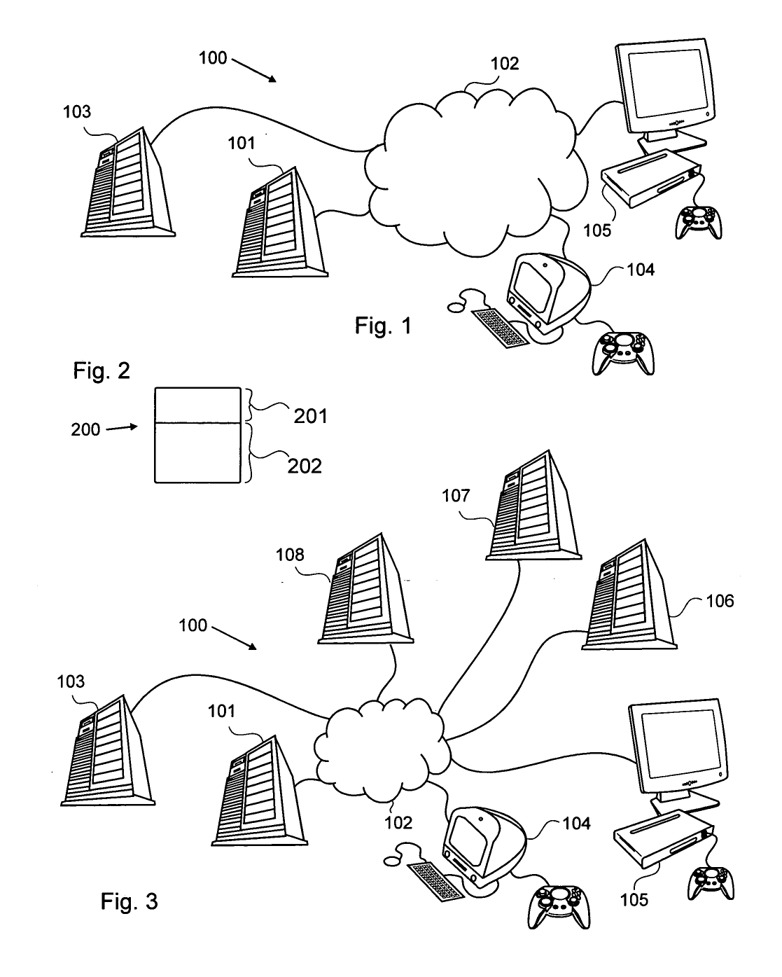

Referring to FIG. 1, a schematic diagram of a video game advertising system according to an embodiment of the invention is shown. The advertising system 100 comprises: a game server 101, a public network 102, an advertising server 103, a first gaming device 104 and a second gaming device 105. In use a user of the first gaming device 104 initiates a video game session by executing a video game application. The video game application comprises instructions for the video game and for supporting delivery and display of advertisements, in the form of product placement advertisements within the game, interstitial advertisements, video advertisements, sound files, images, and splash screens. During the video game session a first advertisement is displayed to a player of the video game. Impression data associated with the advertising impression is stored in a memory of the gaming device. The impression data is stored securely in a log file. If no log file is detected at a known memory location then a new log file is created. A person of skill in the art will appreciate that the known memory location is typically provided in a same device housing as the computing device. Alternatively, many platforms support memories that are viewed as external to the computing device and are suitable for storing of log files therein. For example, in some video game consoles, data is stored via an external proxy. When a second impression related to the first advertisement is provided, the log file is updated to reflect a record of the second impression. The log file is updated until a threshold is exceeded. When the threshold is exceeded the first gaming device 104 verifies the integrity of a data communication path to the advertising server 103 and when the data communication path is determined to be reliable, data associated with the log file is transferred from the first gaming device 104 to a server, for example the advertising server 103. Once the data is transferred to the server, the log file residing on the first gaming device 104 is cleared. Alternatively, the log file is maintained but modified to reflect the transfer of the data. Further alternatively, the log file is deleted.

The log file supports efficient modification to permit reception of new data associated with impressions provided to the user. As these impressions are optionally provided to the video game after the programming of the video game is completed and distributed, it is desirable to know which advertisements and product placements are provided with a known video game and who has received the impressions associated therewith. Additionally, the log file supports encryption of data stored therein. Thus, an unauthorized user reviewing the log file faces a complex task of correctly interpreting or altering the contents of the log file; however the log file remains relatively simple to update by an authorised software program. The log file is generated according to software instructions that prevent a malicious user from simply copying the log file for the purpose of deceiving an advertising server into acknowledging that an impression has been provided more often than it has. Thus, each log file supports unique keying to reduce a likelihood that any two log files are identical. Further, entries within a log file are keyed to prevent record playback attacks on impression data reliability. A person of skill in the art will understand and appreciate how uniquely keyed files are generated and used.

In order to facilitate updating of the log file, an application program interface (API) residing within a video game software program present on the first gaming device 104 is able to update log files that it generates. Additionally, a program provided on a master server is capable of correctly interpreting data stored in log files from a variety of predetermined supported sources. This type of encryption scheme is often referred to as “write once encryption.” A person of skill in the art will appreciate that there are a variety of write once encryption methodologies that support such encryption and updating functionality.

Optionally, different games provided on a given video game device support distinct log files. Ideally, log files are stored in a non-volatile memory of the video game device however this need not be the case. In an alternative embodiment, the log file is automatically uploaded to a non-volatile memory external to the video game device when other data is uploaded from the video game device. Thus, in a video game console that does not support non-volatile memory but does support Internet connectivity, when data associated with a game session is uploaded to a game server the log file is provided to the server, for example the game server, as well. Alternatively, the log file is provided to another server when the game establishes a connection with the Internet. Clearly, in order to maintain integrity of the log file, when the log file is uploaded to an external server, it is either erased or initialized on the video gaming device.

The log files mitigate a variety of problems associated with the accurate reporting of the delivery of advertising content on a computing device. Since the log files have a private portion, creating counterfeit log files is difficult. Similarly, when the log files are generated with a unique identifier copied log files are easily identified thereby complicating the production of illegitimate log files. Additionally, since the log files are optionally updated with new data prior to being sent to an external server, the number of files being sent to the external server is more easily managed.

Since video games are quite popular and there is a desire to maximize cash flow from the video game business, it is expected that advertising in video games will become relatively common. A virtual environment intended to accurately mimic a typical downtown scene has a variety of product placements in it. Although the log files as previously discussed allow accurate reporting of these product placements it is apparent that a potentially large number of log files are likely to be produced in popular multi-player games. It is important that these files be accurately polled to determine what product placements and impressions have been provided. In order to support the sorting and categorizing of log files, the log files are provided with a public portion which comprises easily read data relating to the contents of the log file.

Referring to FIG. 2, a log file 200 comprises: a public portion 201 supporting a file name, and a private portion 202 for storing data associated with advertising impressions. Clearly, a wide variety of variations in the log file are optionally supported. For example, the data stored within the private portion 202 of the log file 200 is optionally encrypted using any of a variety of suitable encryption techniques. Additionally, the public portion 201 of the log file 200 optionally includes a variety of data relating to the origin of the log file 200. Thus, in addition to providing a title for the log file 200, the public portion 201 of the log file 200 optionally supports additional data storage indicative of: the identity of the game, the company that distributes the game, demographic data of the a registered user of the game, a rating of the game, an identifier of at least one advertiser, an identifier of a type of advertisement, a descriptor of the video game device among others. Clearly, other data is optionally provided in the public portion 201. A person of skill in the art will appreciate that while it is beneficial to provide data in the public portion 201 it is also desirable to minimize the overall size of the log file 200 in order to minimize the demands placed on the memory used for storing log files. Similarly, the private portion of the log file optionally supports a variety of data. For example, the private portion 202 of the log file 200 optionally comprises data relating to any of the data described in the public portion 201 in addition to discreet sets of data, each set of data relating to: a type of advertisement; a quality of the advertisement; and a duration of the advertisement; geographic location information associated with the user of the computing device; a degree of user interaction with the advertising media in a virtual gaming environment; and, a skill level of the user. Optionally, data relating to the quality of the advertisement comprises any of: a category of advertisement; a virtual time and location associated with a virtual environment in which the advertisement was viewed; a duration or number of frames and frame rate in which the advertisement was present; a relative measure of the size of the advertisement in comparison with the total size of a display device associated with the gaming device; a camera angle associated with the advertisement; location information relating to a geographical location of the game player; contrast data relating a relative shading of the advertisement in comparison with a virtual environment; a degree of player interaction with the advertisement; and, a player skill level. Optionally, other data is stored within the log file.

Referring to FIG. 3, a schematic diagram of a video game advertising system according to a second embodiment of the invention is shown. The advertising system 100 comprises: a game server 101, a public network 102, an advertising server 103, a first gaming device 104; a second gaming device 105; a triage server 106; a first log file server 107; and, a second log file server 108. When a user of the first gaming device 104 is presented with a supported advertisement a log file is either created or updated. When the log file is uploaded from a gaming device 104 to the advertising server 103, the advertising server 103 reviews the public portion of the log file. Data provided from the public portion of the log file provides information to the triage server 106. The triage server 106 chooses a destination for the log file in dependence upon data provided by the public portion of the log file and a set of predetermined instructions present within a memory of the triage server 106. The triage server 106 will then route the log file to at least one suitable log file server. For the purpose of demonstrating the functionality of the second embodiment of the invention only two log file servers are shown. A person of skill in the art will appreciate that any number of log file servers are optionally supported. A person of skill in the art will also appreciate that the triage server 106 is being accessed in dependence upon predetermined software instructions present in the first gaming device 104. Clearly, additional triage servers are optionally provided in which the triage servers support any of a variety of different log files. For example, a first triage server may service log files provided from a specific game software package, while another game software package operating on the same machine provides log files to a different triage server. Further, still, equivalent retail software packages optionally create log files that are optionally provided to different triage servers in dependence upon, for example, data associated with the platform that the software package is run on, the location of the computing device that the software is being run on, and demographic information associated with a user of the software package. Additionally, an address of the triage server is optionally stored in a memory of the computing device for use in determining a triage server. Optionally, the triage server is located on the same physical platform as any of the system components. When it is time to send a log file the computing device attempts to establish a communications path with the triage server corresponding to the stored address. Optionally, this stored address is changed in response to data supplied via the public network. Thus, if a specific overworked triage server is believed to be receiving too many log files then when a new triage server having a different address is provided, the overworked triage server provides the address of the new triage server to a portion of the gaming devices that it serves thereby diverting log files from that portion of the gaming devices. Clearly, the most opportune time to make such a change occurs when the computing device is in contact with the overworked triage server. Optionally, the gaming device stores a set of addresses corresponding to a set of triage servers and attempts to connect to another server in the event that a first server it attempts to contact is unavailable. Further optionally, some of the memory for storing addresses supports receiving new addresses while other portions store addresses that are fixed. A person of skill in the art will appreciate that the triage servers and log file servers are sufficiently versatile to support a number of different games provided by a set of game publishers.

Once a triage server receives a log file, the public portion of the log file is reviewed. Based upon the public contents of the log file, the log file is routed to any one of a set of log file servers. The log file server receives the log file, stores an identifier for the log file and decodes the private portion of the log file. Since the identifier of the log file is stored, another log file having the same identifier will be treated as suspect. It is recommended that data from a suspect log file be discarded. If a variety of log file servers support a related set of log files then it is suggested that these servers share identifier data to help prevent counterfeit log files which are copies of valid log files from being treated like valid log files.

Using a system according to the second embodiment of the invention the tracking and recording advertising data provided on gaming devices with even occasional public network connections is supported. In some cases, managing a large number of log files is simply not practical. For example, while it is desirable to have comprehensive data regarding the delivery of advertisements in a gaming session such data need not always be comprehensive to provide, for example, an advertising agency necessary data regarding the delivery of their advertisements. Thus, in order to reduce costs, it is often beneficial to simplify the system according to the third embodiment of the invention and decode only a portion of the log files provided. Specifically, instead of reading each log file a statistically significant sample of log files are read providing a statistical model of advertising data. The remaining log files are then assumed to have advertising data consistent with the statistical distribution. Clearly, in order to validate the use of statistical models in this context, the number of log files being decoded is increased to verify the accuracy of the statistical model. The use of statistical models is well understood by those skilled in the art of statistical analysis.

It is expected that log files, once suitably processed will be archived to provide saved archived log files. The log files are archived in a manner that supports the recreation of the original log file. Thus, when a statistical sample is provided, additional data relating to the sample is optionally available by providing the log files associated with the sample from the archived log files. In this way, data provided based upon log files is supported by the original log files. Additionally, in the event that only a relatively small sample of log files are being reviewed to generate a statistical model, a more detailed statistical model is optionally produced using a larger number of log files which optionally include the original relatively small sample of log files. Thus, in the event that it is desired to carefully review a particular set of data after the data has been collected, the presence of the archived log files supports a secondary and optionally more detailed analysis of the log files.

Optionally, data associated with the public portion of the log files is stored in a relational database that allows tracking of the log files based upon their public portions. Thus, if it is desired to create a historical sample of data using metrics associated with the public portions of log files, it is a relatively simple matter to query the relational database, determine the existence of a set of desired log files, determine the location of each of the log files of the set and request copies of those log files.

A person of skill in the art will appreciate that there are a wide variety of advertising techniques suitable for providing services as well as promoting products and services that might not be considered traditional advertising. For example, product placement associated with real trademarks is a form of advertisement. Similarly, providing a soundtrack within a game optionally is used to advertise music. Optionally, the advertisements are downloaded to gaming device via the public network. A person of skill in the art will appreciate that the log files described with reference to embodiments of the invention are also suitable in other applications. For example, log files are optionally used to track product placements in suitably programmed media decoders, such as an application that provides a movie from a digital video disc (DVD) in a personal computer. Assuming that the movie is properly encoded and designed to receive suitable product placements, the log file is useful in providing feedback associated with those advertisements that have been properly provided.

Alternatively, instead of maintaining a single log file for a single game, a log file is maintained for numerous games, for example, for all games by a same publisher. In such an example, log file maintenance is no more complicated due to the consistency of the log file access software, but transmission of small log files is obviated thereby improving communication efficiency and server efficiency. Within a log file of this type, game related data such as a game identifier is stored for each log entry to identify not only the advertisement, but the game within which the advertisement is displayed. Alternatively, all advertising data is recorded within the log file by a process that is in accordance with industry standards allowing for a single log file to be maintained for numerous games and even for numerous publishers. Optionally, for each impression a unique impression location identifier is stored indicating the exact game and location within the game where the impression was made.

In an alternative embodiment, a single log file is maintained for a single advertisement within a multi player environment such that the log file receives updates of impression data relating to impressions relating to the advertisement. For example, a billboard within a massively multiplayer online game environment has impression data relating thereto stored within a single log file indicating how many of the online gamers have been impressed by the advertisement. Further, it includes log entries for each such impression. This allows for evaluation of specific locations within massively multiplayer on-line worlds in terms of value, reach and frequency. Thus, a log file relating to a single location allows for accurate and real impression reporting for mapping of a virtual location onto existing advertising valuation standards. Optionally, the log file relates uniquely to a single advertisement location within a virtual space.

Numerous other embodiments of the invention will be apparent to one of skill in the art without departing from the spirit and scope of the invention.

What is claimed is:

1. A method of providing feedback data relating to advertising content, comprising:
providing an advertisement during the video game session, the video game session occurring on a video game system;
providing a log file in dependence upon the advertisement, the log file comprising a public portion and a private portion;
providing the log file from the video game system to a first server; and,
determining a destination for the log file at the first server, the destination determined in dependence upon data present within the public portion of the log file.

2. A method of providing feedback data relating to advertising content according to claim 1, comprising providing a plurality of log file servers, and wherein the determined appropriate destination for the log file is a log file server of the plurality of log file servers.

3. A method of providing feedback data relating to advertising content according to claim 1, wherein the public portion of the log file comprises data associated with a title of a software program, the software program associated with the video game session.

4. A method of providing feedback data relating to advertising content according to claim 3, wherein the public portion of the log file comprises data associated with a developer of the software program.

5. A method of providing feedback data relating to advertising content according to claim 3, wherein the private portion of the log file comprises data relating to a quality of an advertisement.

6. A method of providing feedback data relating to advertising content according to claim 3, wherein the private portion of the log file comprises data relating a plurality of advertisements.

7. A method of providing feedback data relating to advertising content according to claim 6, wherein the private portion of the log file comprises data relating to a quality of advertisement for each of the plurality of advertisements.

8. A method of providing feedback data relating to advertising content according to claim 5, wherein the quality of the advertisement corresponds to a type of the advertisement.

9. A method of providing feedback data relating to advertising content according to claim 5, wherein the quality of the advertisement relates to one of a duration of the advertisement and a number of frames associated with the advertisement.

10. A method of providing feedback data relating to advertising content according to claim 5, wherein the advertisement is an image and the quality of the advertisement relates to a relative measure of the size of the advertisement relative to a size of a display device associated with the computing device.

11. A method of providing feedback data relating to advertising content according to claim 5, wherein the quality of the advertisement relates to a camera angle.

12. A method of providing feedback data relating to advertising content according to claim 5, wherein the quality of the advertisement relates to a location of the computing device.

13. A method of providing feedback data relating to advertising content according to claim 5, wherein the quality of the advertisement relates to a relative measure of interaction between a representation of a user of the computing device within a virtual environment associated with the video game session and virtual product present within the same virtual environment, the virtual product corresponding to the advertisement.

14. A method of providing feedback data relating to advertising content according to claim 5, wherein the quality of the advertisement relates to a skill level associated with the video game session.

15. A method of providing feedback data relating to advertising content according to claim 1, comprising:
determining the existence of an appropriate log file; and,
updating the log file in dependence upon providing a second advertisement.

16. A method of providing feedback data relating to advertising content according to claim 15, wherein updating the log file comprises updating the private portion of the log file.

17. A method of providing feedback data relating to advertising content according to claim 16, comprising:
providing a read security key and the log file to a decryption program provided on a log file server; and,
decrypting the contents of the private portion of the log file using the read security key.

18. A method of providing feedback data relating to advertising content according to claim 17, wherein providing a log file in dependence upon the advertisement does not comprise providing the read security key.

19. A method of providing feedback data relating to advertising content according to claim 18, wherein data corresponding to the read security key is not present in a non-volatile memory of the computing device.

20. A method comprising:
providing an advertisement during a video game session, the video game session occurring on a video game system and forming part of a massively multiplayer online game;
providing a log file on a first server and in dependence upon the advertisement, the log file comprising a public portion and a private portion;
providing impression data from the video game system to the first server; and,
storing the impression data within the log file associated with the advertisement.

21. A method according to claim 20 comprising:
determining user data associated with a gamer participating in a session of the massively multiplayer online game, and
wherein the private portion of the log file comprises the user data.

22. A method according to claim 21 comprising:
determining second user date associated with a second gamer in the session of the massively multiplayer online game.

23. A method according to claim 22 comprising:
providing a second log file comprising a public portion and a private portion wherein the private portion of the second log file comprises the second user data associated with the second gamer.

24. A method according to claim 22 wherein the private portion of the log file comprises the user date associated with a second gamer.

25. A method according to claim 22 wherein the user data comprises data relating to a geographic location of the gamer.

26. A method according to claim 22 wherein the user data comprises data relating to a duration during which the advertisement is impressed upon the gamer.

27. A method according to claim 26 wherein the advertisement is an image and the user data comprises data relating to a relative size of the image as viewed by the gamer when said image is impressed upon the gamer.

28. A method according to claim 27 wherein the user data comprises data relating to a camera angle of the image as viewed by the gamer when said image is impressed upon the gamer.

29. A method according to claim 21 wherein the user data comprises data relating to a relative measure of interaction between a representation of the gamer and the advertisement.
